(19) United States
(12) Patent Application Publication
(10) Pub. No.: US 2007/0235540 A1
(43) Pub. Date: Oct. 11, 2007

(54) Small field of view bar code reader

(75) Inventors: Calvin Jon Marlett, LaCrescenta, CA (US); Lily Ai Ray, Altadene, CA (US); Louis Sinn, LaVerne, CA (US)

Correspondence Address: PILLSBURY WINTHROP SHAW PITTMAN, LLP, P.O. BOX 10500, MCLEAN, VA, 22102, US

(73) Assignee: Xerox Corporation, Stamford, CT (US)

(21) Appl. No.: 11/398,593

(22) Filed: Apr. 6, 2006

(51) Int. Cl. G06K 7/10; G06K 13/00

(52) U.S. Cl. 235/454; 235/470; 235/475

(57) ABSTRACT

The present disclosure involves reducing the space required inside a printer or other machine in which a bar code or other machine readable indicia reader is installed. In an embodiment, machine readable indicia are read from close range by mounting a sensor in close proximity to the path along which a medium is moved. The sensor reads the indicia as it is moved past the sensor and transmits the image data to a processor, which may optionally be mounted remotely, to decode the data.

### FIELD

The present disclosure relates to indicia readers mounted within printers or other apparatuses and, more particularly, to indicia readers that scan machine readable indicia on a medium moving within the apparatus.

### BACKGROUND

Bar codes and other machine readable indicia are read by readers within printers as a means of maintaining document integrity, for job verification, for providing instructions to the printer or human operator, or for many other uses.

United States Patent Application Publications US 2002/0097407 A1 and US 2005/0060650 A1, both of which are incorporated herein by reference in their entirety, disclose a production monitor controller and a graphic user interface within a document production system and discuss the use of “traveler sheets” that have machine readable indicia printed thereon and are associated with document production jobs for any of the above-mentioned purposes.

Reading of machine readable indicia in conventional printers or other document production systems is typically accomplished using bar code readers that must scan an entire bar code at once in order to capture the information. That is, the entire bar code must be within the reader's field of view to be scanned properly. As a result, these bar code readers must be mounted at a certain standoff distance from the bar code, typically about four to six inches, thereby increasing the amount of space required to house them inside a printer. Even when the bar code reader is maintained at a significant standoff distance, it may still be unable to read bar codes that are greater than a given size since it must “see” the entire bar code at once.

These bar code readers are sometimes accommodated by making significant changes to the internal structural elements of the printers or by restricting the size of the bar code that is read. Creating clearance space within a printer by cutting sheet metal, for example, likely increases the jam rate of the machine and makes installation difficult and expensive. Also, end users tend to desire more compact machines and the empty stand-off space for a reader is unused space. Ensuring that bar codes are not larger than a specified size adds a further layer of oversight and hurdles in accommodating conventional bar code scanners, and limits the versatility of the reader.

FIG. 1 depicts a conventional bar code reader 10 that emits a laser beam to scan a bar code 14 printed on a medium 12, such as a piece of paper, that is being moved within a printer. Bar code readers 10 such as this are mounted within the printer housing as an efficient means of document verification and/or inventory. The bar code reader is shown in FIG. 1 as being mounted on a printer subassembly, which includes various elements 18 of a conveyor mechanism such as rollers or belts. As a surface 12 having a bar code 14 thereon passes, the bar code reader 10 scans the bar code 14 when the entire bar code 14 is within the optical envelope 16.

A laser source within the bar code reader 10 is emitted and reflected by a rotating polygon mirror or an oscillating mirror in the optical train in order to sweep over the bar code 14. Thus, the movement of a light source across the various light and dark bars in scanning the bar code 14 is accomplished by a mechanism within the bar code reader itself. Since the emitted light source has a limited range of “sight,” any bar code that is larger than the optical envelope 16 cannot be fully scanned and the code, therefore, cannot be read. The size of the optical envelope 16 can be increased by placing the bar code reader 10 at a further distance away from the bar code 14. This solution has obvious drawbacks with regard to space considerations within the printer.

### SUMMARY

The present disclosure provides an apparatus that uses a medium on which a machine readable indicia is provided. The apparatus includes a conveyor mechanism that moves the medium along a path and a sensor mounted in close proximity to the path and having a field of view. The sensor is operable to transmit sensed image data. The apparatus further includes a processor that is in electronic communication with the sensor and configured to decode the sensed image data. The sensor and the processor are operable to scan the machine readable indicia with the sensor progressively scanning the machine readable indicia as the medium moves past the sensor and the processor decoding the sensed image data.

The disclosure further provides a method of reading machine readable indicia on a moving medium within an apparatus. The method includes the acts of moving the medium within the apparatus past a sensor having a field of view and that is in close proximity to the moving medium, and scanning the machine readable indicia on the medium with the sensor. The sensor progressively transmits image data to a processor, which decodes the image data.

Other objects, aspects, and advantages of the disclosure will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is a schematic diagram of a conventional laser scanning bar code reader mounted on a printer subassembly; and

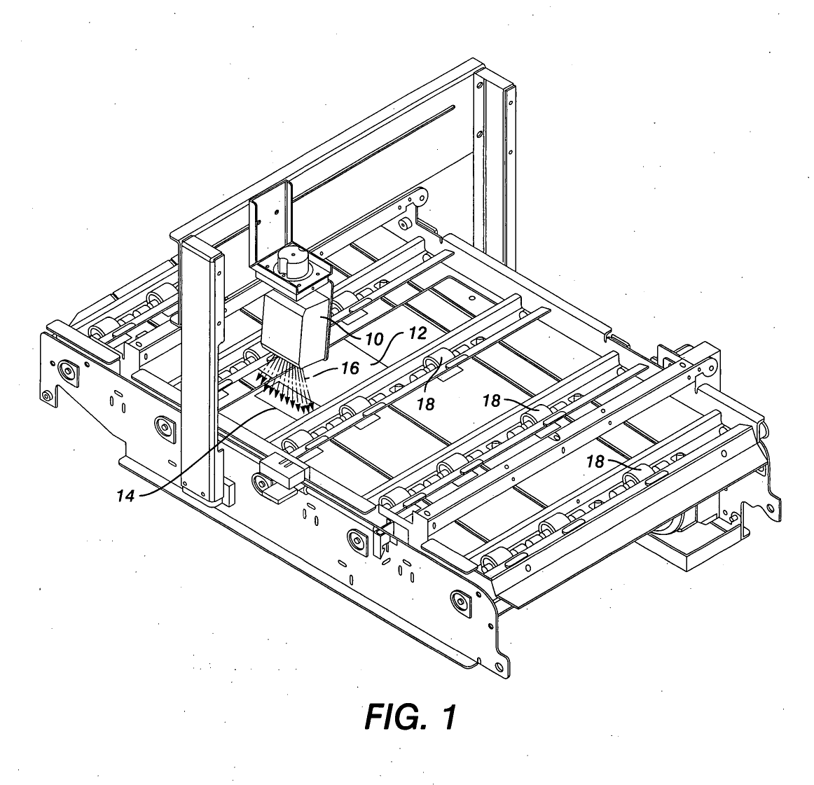

FIG. 2 is a schematic diagram of a bar code reader mounted on a printer subassembly in accordance with the present disclosure.

An embodiment will be described with reference to the accompanying drawings. Corresponding reference characters indicate corresponding parts throughout the several views. The description as set out herein illustrates an arrangement of an embodiment of the present disclosure and is not to be construed as limiting its scope in any manner.

### DETAILED DESCRIPTION

The disclosed embodiment is designed to be used in a printer, such as those disclosed in the above-incorporated patent publications. For purposes of the present disclosure, the term “printer” is meant to include any processing machine that prints text, graphics, bar codes, or other images upon or from a printing medium, such as paper. Printers include, but are not limited to, photocopiers, facsimile machines, scanners, stand-alone printers, and combinations thereof. Such a printer will include a printer device for forming an image on a substrate medium moved along a path within the printer. Such a printer device could be of any type, including ones for laser printing, inkjet printing, ink ribbon printing, gravure roller printing, xerographic processes, etc.

As is well known, a printer will have a housing containing the various functional elements of the printer. These include a conveyor mechanism for moving one or more substrate media through the printer, and the printing device that prints images, text, etc. on the substrate medium. The conveyor mechanism may take any form, and may include belts, rollers, etc. The conveyor mechanism will typically be responsible for moving each individual substrate from a sheet feeder along a path in the printer to a discharge exit, where an exit tray may be located. The printing device (which may be of any type) may be located along the path for printing images, graphics, text, etc. on the substrate medium.

The specific details of such printers are well known, and need not be detailed herein. The present embodiments may be used with any such printer now known or later developed. Moreover, the present embodiments may be used with any apparatus that moves a medium along a path of travel where reading of machine readable indicia on the medium is desired. Thus, the present embodiments are not limited to use in printers.

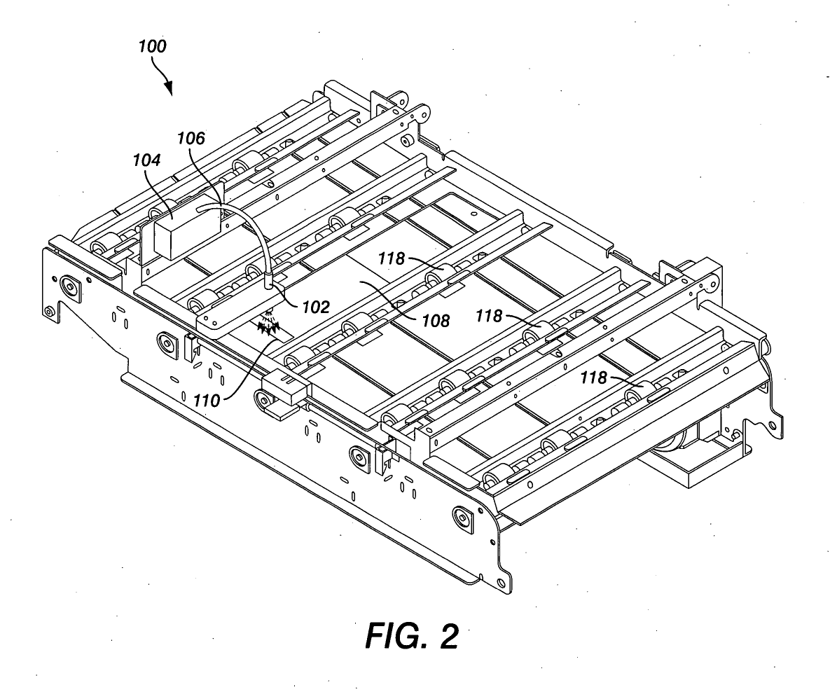

FIG. 2 is a schematic representation of an indicia reader in the form of a bar code reader 100 in accordance with the present disclosure. The bar code reader is shown as being mounted on a printer subassembly, which includes various elements 118 of a conveyor mechanism such as rollers or belts. The bar code reader 100 includes a sensor 102, processor 104 (which may be adjacent the sensor 102 or mounted remotely somewhere else in or on a printer or other apparatus), and data link 106. The sensor 102 and the processor 104 may be mounted within a printer in close proximity of a feed path along which a moving sheet of paper 108 (or other media) moves having a bar code 110 printed thereon. There is no minimum standoff distance between the sensor 102 and the paper 108, so the sensor 102 may be mounted as close as is necessary or desirable, with regard to available space within the printer, as long as it does not interfere with the movement of the paper 108. Mounting the processor 104 remotely in the printer (or other apparatus) is desirable as it may be placed at a more convenient location in the context of the overall design of the printer or other apparatus.

The sensor 102 includes a lens, a light source, and a photoconductor. The light source emits light, such as a laser beam, which then passes through the lens and is directed to the bar code 110. The lens may be a wide angle lens, such as an anamorphic lens, in order to stretch the laser beam in the cross scanning direction to even out any irregularities in the printed bars of the bar code 110. As the bar code 110 passes beneath or above the lens and the emitted light, the photoconductor senses the varying light reflection across the light and dark bars of the bar code 110, converts the optical image data into electronic image data, and transmits the electronic image data to the processor 104 through data links 106, such as electrical or fiber-optic wires.

The process is carried out progressively as the medium (e.g., paper 108) moves past the sensor. That is, the sensor 102 senses each bar or sections of the bar code 110 as it passes such that it is not necessary for the entire code 110 to be within the field of view of the sensor 102. The processor 104 may then progressively decode the received data and output the information represented by the bar code 110. This allows bar codes that are larger than the sensor's field of view to be scanned.

The present disclosure additionally contemplates the reading of machine readable indicia other than bar codes. Any indicia amenable to being read progressively by a sensor using light or other electromagnetic energy (such as infrared beams) would be an appropriate application for the present embodiment.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. An apparatus that uses a medium on which a machine readable indicia is provided comprising:
a conveyor mechanism for moving the medium within the apparatus along a path;
a sensor mounted in close proximity to the path and having a field of view, the sensor being operable to transmit sensed image data; and
a processor in electronic communication with the sensor, the processor configured to decode the sensed image data,
wherein the sensor and the processor are operable to scan the machine readable indicia with the sensor progressively scanning the machine readable indicia as the medium moves past the sensor and the processor decoding the sensed image data.

2. The apparatus according to claim 1, wherein the sensor comprises a light source and a lens.

3. The apparatus according to claim 2, wherein the lens is a wide angle lens.

4. The apparatus according to claim 2, wherein the lens is an anamorphic lens.

5. The apparatus according to claim 1, wherein the field of view of the sensor is smaller than the machine readable indicia.

6. The apparatus according to claim 1, wherein the apparatus is a printer, the medium used by the printer is a substrate, and the conveyor mechanism is constructed to move the substrate along the path within the printer, the printer further comprising a printing device positioned along the path and constructed to print on the substrate.

7. A method of reading machine readable indicia on a moving medium within an apparatus comprising:
moving the medium along a path within the apparatus past a sensor that has a field of view and that is mounted in close proximity to the path;
scanning the machine readable indicia on the medium with the sensor;
progressively transmitting image data from the sensor to a processor; and
decoding the image data with the processor.

8. The method according to claim 7, wherein the field of view of the sensor is smaller than the machine readable indicia.

9. The method according to claim 7, wherein the sensor has a wide angle lens.

10. The method according to claim 9, wherein the lens is an anamorphic lens.

11. The method according to claim 7, wherein the processor is mounted within the apparatus.

12. The method according to claim 7, wherein the apparatus is a printer.
